(19) United States
(12) Patent Application Publication
(10) Pub. No.: US 2010/0324767 A1
(43) Pub. Date: Dec. 23, 2010

(54) ELECTRIC VEHICLE WITH HEADS-UP CONTROLS

(76) Inventor: Michael D. Tomberlin, Augusta, GA (US)

Correspondence Address: MEHRMAN LAW OFFICE, P.C., P.O. Box 420797, ATLANTA, GA, 30342, US

(21) Appl. No.: 12/822,116

(22) Filed: Jun. 23, 2010

Related U.S. Application Data
(60) Provisional application No. 61/219,636, filed on Jun. 23, 2009.

(51) Int. Cl. B60W 50/08

(52) U.S. Cl. 701/22

(57) ABSTRACT

An electric vehicle with controls for changing the operational parameters of the vehicle while the vehicle is in motion. These controls are preferably located on the steering wheel, steering column, or other locations where the selectors can be accessed by the operator while facing forward operating the vehicle from an intended operator's seating position. With the selectors in the heads-up position, the operator does not have to look away from the road to change the operational settings of the vehicle while the vehicle is in motion.

### REFERENCE TO RELATED APPLICATION

This application claim priority to U.S. Provisional Patent Application Ser. No. 61/219,636 filed Jun. 23, 2009, which in incorporated herein by reference.

### FIELD OF THE INVENTION

The present invention relates to low speed electric vehicles (LSVs) and, more particularly, relates to an electric vehicle with heads-up controls for changing the operational drive parameters of the vehicle while the vehicle is in motion.

### BACKGROUND OF THE INVENTION

Each year over 150,000 electric golf carts are leased to golf courses in the United States. These leases are typically for four years. When a golf course renews its fleet of cars, the old cars are typically sold to individuals for private use in gated communities, private property and driven around town. The result is that over 150,000 used and new electric golf cars enter into the marketplace each year. The market is also growing in the low speed vehicle (LSV) segment where the same types of vehicles are converted to street legal status under Federal Motor Vehicle Safety Standards.

One of the biggest concerns of the private owner of an electric golf cart or street legal LSV used on the roadways is safety and convenience of operation in traffic with other vehicles. The operational parameters of the electric vehicle, such as low speed torque, acceleration or pickup, and top speed are usually programmable features of an electronic motor controller. However, these parameters trade off against each other and the operational efficiency, and thus the range, of the vehicle. In conventional electric vehicles, although these parameters are adjustable, they can only be changed by stopping the vehicle and connecting a hand-held programmer to the vehicle's control unit to reset the operational parameters. The operator is therefore forced to pick a particular set of operational parameters and live with them until they are changed.

Using an electric vehicle on the roadway, however, presents changing driving conditions for which different sets of operational parameters are best suited. For example, a maximized low-speed torque setting is desirable when climbing a hill, a maximized top speed setting is desirable when traveling on a level road with relatively fast traffic, a low top speed setting is desirable when using the vehicle on a golf course or campus with a low speed limit, and a maximized acceleration setting is desirable when the vehicle is entering traffic or attempting to pass. In addition, when cruising at a medium speed the most efficient setting for the selected speed is desirable to maximize the vehicle range at the selected speed. Unfortunately, these operational setting are mutually exclusive as the parameters can only be set to maximize one of these objectives at a time. Accordingly, there is a need for an electric vehicle that is not limited to a single set of programmable operational settings during an operational session of the vehicle.

### SUMMARY OF THE INVENTION

The present invention meets the needs described above in an electric vehicle with controls for changing the operational parameters of the vehicle while the vehicle is in motion. These controls are preferably located on the steering wheel, steering column, or other locations where the selectors can be accessed by the operator while facing forward operating the vehicle from the intended operator's seating position. With the selectors in the heads-up position, the operator does not have to look away from the road to change the operational settings of the vehicle while the vehicle is in motion.

### BRIEF DESCRIPTION OF THE DRAWINGS

FIG. 1 is a conceptual illustration of a first heads-up control panel including selectors for changing the operational parameters of an electric vehicle located on a first side of the steering column of the vehicle.

FIG. 2 is a conceptual illustration of a heads-up display including indicators showing the settings of the selectors for changing the operational parameters of the electric vehicle located on the instrument panel of the vehicle.

FIG. 3 is a conceptual illustration of a second heads-up control panel including selectors for changing the operational parameters of an electric vehicle located on a second side of the steering column of the vehicle.

### DETAILED DESCRIPTION

The present invention may be deployed as a heads-up control panel and associated heads-up display for controlling the operational parameters of an electric vehicle while the vehicle is in motion. The selectors of the heads-up control panel allow the operator to change the operational parameters while the vehicle is in motion without stopping the vehicle or turning their away from the roadway while changing the parameters. This allows the operator to change the operational to adjust the performance of the vehicle to changing speed limits, traffic, and road conditions while the vehicle is in motion. Although the heads-up control panels in the illustrative embodiments shown in the appended figures are located on the steering column, the control panel could alternatively be located in any location where the control panel can be seen and controlled by the operator from a heads-up, facing forward position. For a typical electric vehicle, this generally requires locating the control panel above the bottom edge of the windshield of the vehicle in front of the intended operator's seating position. For example, the control panel could be located on the steering wheel, the instrument panel, the windshield, a portion of the frame supporting the windshield, or any other suitable heads-up, facing forward position.

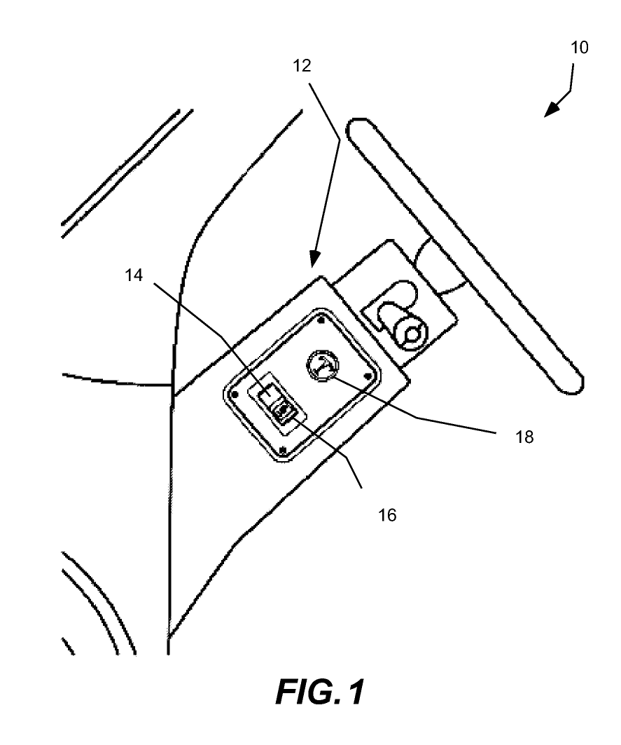

Turning now to the figures, FIG. 1 is a conceptual illustration of an electric vehicle 10 having a first heads-up control panel 12 located on a first side of the steering column. The control panel 12 includes a driving mode switch 14, which has a first position that sets the operational parameters of the vehicle to an “economy mode” setting, which minimizes the electric draw of the motor to maximize the range of the vehicle. The “economy mode” setting achieves maximized range with the trade offs of reduced acceleration and low speed torque. The driving mode switch 14 also has a “high performance” setting, which allows for maximized acceleration and low speed torque. The “high performance” setting is typically used for defined periods, such as operation on roads in relatively fast traffic and on hills. The control panel 12 also includes a “turbo” button 18 that maximizes the motor output available to the throttle input for a predetermined period of time, such as 30 seconds. The “turbo” button” is typically useful when entering traffic, passing, or traveling up a short hill.

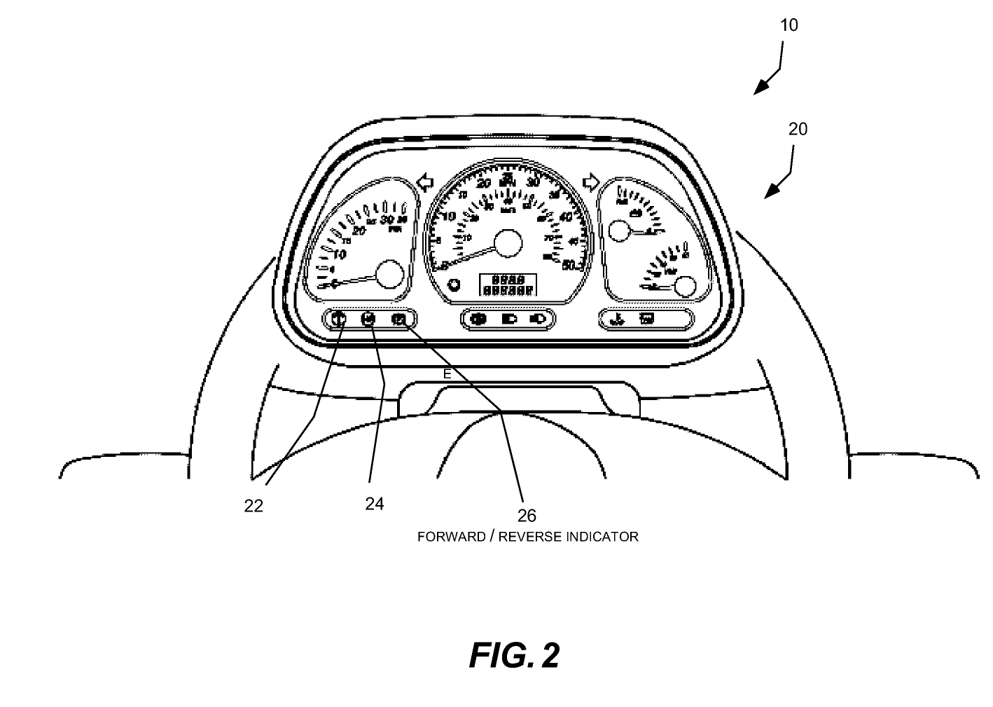

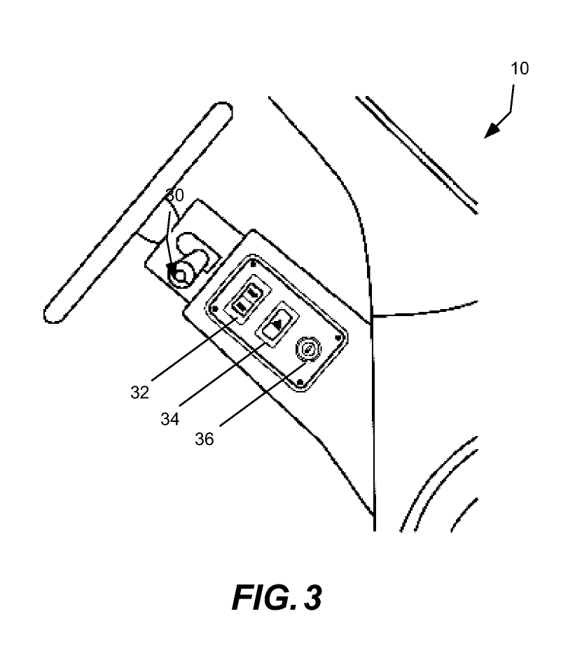

FIG. 2 is a conceptual illustration of a heads-up display 20 located on the instrument panel of the vehicle including indicators showing the settings of the selectors that change the operational parameters of the electric vehicle. The heads-up display 20 includes a “turbo mode” indicator 22, a “high performance” mode indicator 24, and a reverse mode indicator 26. The “turbo mode” indicator 22 is illuminated while the vehicle responds to depression of the “turbo” button 18 (shown in FIG. 1) and the “high performance” mode indicator 24 is illuminated when the driving mode switch 14 (shown in FIG. 1) is set to “high performance” setting. In addition, the reverse mode indicator 26 is illuminated when the vehicle direction switch 32 (shown in FIG. 3) is set to reverse.

FIG. 3 is a conceptual illustration of a second heads-up control panel 30 including selectors for changing the operational parameters of the electric vehicle located on a second side of the steering column of the vehicle. The control panel 30 includes a vehicle direction switch 32, which typically includes forward, neutral, and reverse settings. The control panel 30 also includes an emergency flasher switch 34 and a key switch 36 for turning the vehicle on and off.

The invention claimed is:

1. An electric vehicle, comprising a heads-up control panel comprising selectors for setting operational parameters of the vehicle located where an operator of the vehicle has access to the selectors while facing forward operating the vehicle from an intended operator's seating position.

2. The electric vehicle of claim 1, wherein the selectors include a driving mode switch having an “economy mode” setting that minimizes the amp draw from the motor to maximize the range of the vehicle and a “high performance” setting that allows for faster acceleration and maximum low speed torque.

3. The electric vehicle of claim 1, wherein the selectors include a “turbo” selector that maximizes the motor output available to the throttle input for a predetermined period of time.

4. The electric vehicle of claim 1, wherein the selectors include a vehicle direction switch having forward and reverse settings.

5. The electric vehicle of claim 1, wherein the selectors include an emergency flasher switch.

6. The electric vehicle of claim 1, further comprising a heads-up display including indicators showing the settings of the selectors for changing the operational parameters of the electric vehicle located on the instrument panel of the vehicle.
